(19) United States
(12) Patent Application Publication
(10) Pub. No.: US 2009/0172395 A1
(43) Pub. Date: Jul. 2, 2009

(54) System and Method for Service Virtualization Using a MQ Proxy Network

(75) Inventors: David De-Hui Chen, Cary, NC (US); Elio J. Romero, Apex, NC (US); Richard E. Salz, Reading, MA (US); Lance A. Walker, Louisville, CO (US)

Correspondence Address: CAHN & SAMUELS, LLP, 1100 17th STREET, NW, SUITE 401, WASHINGTON, DC, 20036, US

(73) Assignee: INTERNATIONAL BUSINESS MACHINES CORPORATION, Armonk, NY (US)

(21) Appl. No.: 11/967,606

(22) Filed: Dec. 31, 2007

(51) Int. Cl. H04L 9/00; G06F 15/16

(52) U.S. Cl. 713/168; 709/207

(57) ABSTRACT

A system, method, and computer program product for transmitting message traffic encapsulating a MQ network having a plurality of MQ clients coupled to a MQ queue via at least one MQ queue manager and at least one MQ proxy server coupled to the plurality of MQ clients. The at least one MQ proxy server retrieves a message from a first MQ client coupled thereto, evaluates the message content and forwards the message to the MQ queue via a designated MQ queue manager. If the destination MQ client is served by a second MQ proxy server the originating MQ proxy server notifies the second MQ proxy server coupled to the second MQ client. The second MQ proxy server retrieves the message from the MQ queue thru the designated MQ queue manager, evaluates the message content and forwards the message to the second MQ client. If the first MQ client and the second or destination MQ client are served by the same MQ proxy server, then the MQ proxy server will just retrieve the message from the MQ queue through the designated MQ queue manager and forward the message to the second MQ client.

### I. FIELD OF THE INVENTION

This invention relates in general to the field of computer systems and Service Oriented Architecture (SOA) and in particular to the field of decoupling the application endpoints and virtualizing services via the use of a proxy server that operates in a MQ environment.

### II. DESCRIPTION OF THE PRIOR ART

MQ protocol is used to simplify the communications between applications and provide assured once only asynchronous communications.

Queue managers provide the messaging services and manage objects like queues and channels. Queue managers use transmission queues to move messages to remote queues owned by other queue managers. They provide triggering services, enabling applications to be started when sufficient messages arrive for processing. They also handle the conversion of character sets within messages between platforms. On distributed systems, MQ queue managers can act as transaction coordinators, using two-phase commit to preserve the transactionality of operations to databases and queues.

Queue managers handle the recovery, persistence and assured delivery of messages. In persistent or semipersistent messaging, the queue manager logs message data to disk. MQ queue managers are often backed up in high-availability environments.

MQ systems use channels to connect its queue managers, and to connect MQ clients to them. Channels are logical communication links. A message channel is defined to connect one queue manager to another—revered to as server-to-server communication. These channels are unidirectional, and are often defined in pairs. At either end of these message channels, sender and receiver agents—or movers—coordinate the communications link.

MQ clients also use channels to connect to the queue managers of MQ servers, although a different kind of channel is used in this case, because clients do not have queue managers. Client channels are bidirectional. Some channels can be defined automatically by the MQ system. Queue managers contain a message channel agent (MCA) that is responsible for channels.

Two or more MQ queue managers reside on either side of the firewall. The safe zones are considered to be the zones inside the firewalls. Channels are defined between these queue managers enabling messages to be transported in either direction between the trusted network and the zone outside the firewall or within a zone. This allows the multiplexing of logical message flows through a few well defined pipes through the firewall, reducing required administration and potential vulnerabilities.

Security screening is performed at the secure MQ transport queue layer. Messages with differing levels of security are generally multiplexed differently.

Channels are defined as needed on queue managers to access other specific queue managers providing message based applications services.

MQ clients are installed on various applications on both sides of the firewall. Message services utilize the client connections to put and get messages to and from the local queue managers.

Messages traveling from one client to another are transported to the queue manager coupled to the client originating the message and then routed to a second queue manager sharing a direct connection to the client designated as recipient or the ultimate message destination. Messages traveling in the other direction, from the second MQ client to the first MQ client, can traverse in reverse order or via other path.

FIG. 1 illustrates a block diagram showing the basic architecture of an example MQ Messaging system. MQ client A1 (130) is coupled to MQ queue 120 through a MQ queue manager A (110). MQ clients 1B, 2B, and 3B (132, 134, 136) are coupled to MQ queue, 125 through MQ queue manager B, (115). The MQ clients and the serving MQ queue manager(s) are coupled through physical connections and provide a high level of security.

A message transmitted from a MQ client, for example client 1A (130) is forwarded to the MQ queue manager A (110) who receives the message from the MQ client 1A (130) and stores the message traffic in the MQ queue (120) via a PUT command. The first MQ queue manager A (110) forwards the message to the second MQ queue manager (115) which stores the message traffic in MQ queue (125). MQ Client 2B (134) retrieves the stored message traffic from the MQ queue (125) via a GET command through the MQ queue manager (115).

A cluster is a network of queue managers that are logically associated in some way. MQ queue managers may be grouped in a cluster so that queue managers can make the queues that they host available to every other queue manager in the cluster. If the necessary network infrastructure is in place, any queue manager can send a message to any other queue manager in the same cluster without the need for explicit channel definitions, remote-queue definitions, or transmission queues for each destination.

### III. SUMMARY OF THE INVENTION

Disclosed is a system for transmitting message traffic encapsulating a MQ network having a plurality of MQ clients coupled to a MQ queue via at least one MQ queue manager and at least one MQ proxy server coupled to the plurality of MQ clients. The at least one MQ proxy server retrieves a message from a first MQ client coupled thereto, evaluates the message content and forwards the message to the MQ queue via a designated MQ queue manager. If the destination MQ client is served by a second MQ proxy server it will be notified by the normal MQ mechanism. The second MQ proxy server retrieves the message from the MQ queue thru the designated MQ queue manager, evaluates the message content and forwards the message to the second MQ client. If the first MQ client and the second or destination MQ client are served by the same MQ proxy server, then the MQ proxy server will just retrieve the message from the MQ queue through the designated MQ queue manager and forward the message to the second MQ client. MQ proxy servers are transparent to both MQ clients and MQ queue managers.

Also disclosed is a method for transmitting message traffic via an intermediate server application coupled to a plurality of MQ clients having the steps of receiving a MQ message from the sending MQ client; authenticating the MQ message received from the sending MQ client; determining the MQ message queue that should handle the message based on the MQ client designated as recipient and, forwarding the MQ message to the designated MQ message queue through a MQ queue manager coupled to the designated MQ message queue; retrieving the MQ message from the designated MQ message queue through the MQ queue manager; authenticating the MQ message retrieved from the MQ queue manager and, forwarding the MQ message to the recipient MQ client.

Also disclosed is a system for transmitting message traffic including a MQ network having a plurality of MQ clients coupled to a MQ queue via at least one MQ queue manager; means for receiving a MQ message from a first MQ client; means for authenticating the MQ message received from the first MQ client; means for determining the message queue of which proxy server should handle the message and, means for forwarding the MQ message to the designated MQ message queue through the MQ queue manager coupled to the designated message queue; means for retrieving the MQ message from the designated message queue through the MQ queue manager coupled to the designated message queue; means for authenticating the MQ message retrieved from the MQ queue manager and, means for forwarding the message to the designated MQ client recipient.

Also disclosed is a computer program product comprising computer usable medium having; a computer usable program code for transmitting secure message traffic via an intermediate server application coupled to a plurality of MQ clients, the computer program product featuring computer-usable program code for receiving a MQ message from a first MQ client; computer-usable program code for authenticating the MQ message received from the first MQ client; computer-usable program code for determining the MQ message queue that should handle the message and, computer-usable program code for forwarding the MQ message to the designated MQ message queue through a MQ queue manager coupled to the designated MQ message queue; computer-usable program code for retrieving the MQ message from the designated MQ message queue through the MQ queue manager; computer-usable program code for authenticating the MQ message retrieved from the MQ queue manager and, forwarding the MQ message to the designated MQ client recipient.

### IV. BRIEF DESCRIPTION OF THE DRAWINGS

In order to describe the manner in which the above-recited invention and other advantages and features of the invention can be obtained, a more particular description of the invention briefly described above will be rendered by reference to specific embodiments thereof which are illustrated in the appended documents and drawings. Understanding that these drawings depict only typical embodiments of the invention and are not therefore to be considered to be limiting of its scope, the invention will be described and explained with additional specificity and detail through the use of the accompanying drawings.

FIG. 1 illustrates a block diagram of a traditional MQ messaging system.

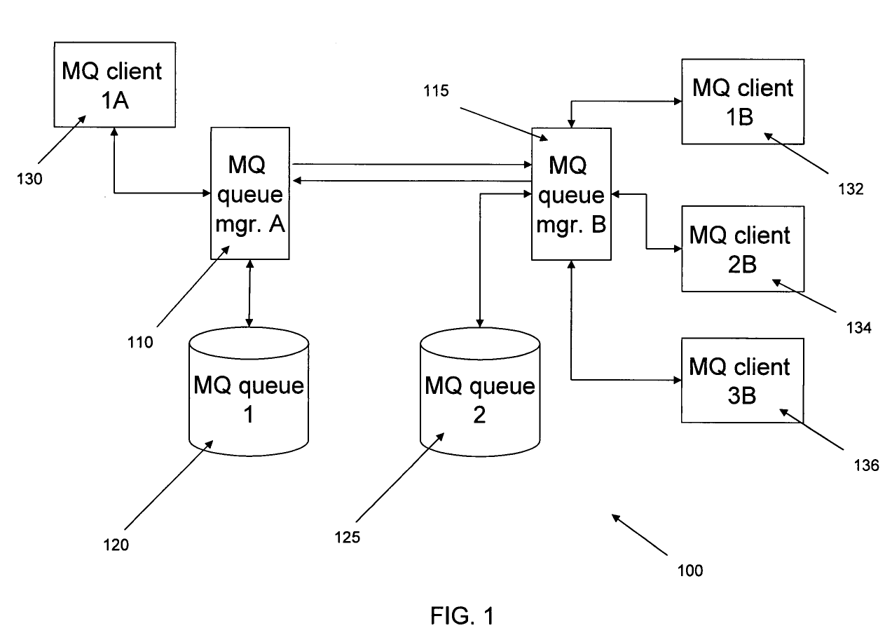

FIG. 2A illustrates a block diagram of an example embodiment of a MQ proxy server messaging system serviced by two proxy servers.

FIG. 2B illustrates a block diagram of an example embodiment of a MQ proxy server messaging system having multiple MQ queues serviced by two proxy servers.

FIG. 3 illustrates a flow diagram of an example embodiment of the MQ proxy server messaging system on the initiating side of the MQ queue.

FIG. 4 illustrates a flow diagram of an example embodiment of the MQ proxy server messaging system on the destination side of the MQ queue.

FIG. 5 illustrates a block diagram of an example embodiment of a MQ proxy server messaging system serviced by a single proxy server.

FIG. 6 illustrates a block diagram of an example embodiment of a MQ proxy server messaging system featuring multiple MQ queues serviced by three proxy servers.

### V. DETAILED DESCRIPTION

Various embodiments are discussed in detail below. While specific implementations of the disclosed technology are discussed, it should be understood that this is done for illustration purposes only. A person skilled in the relevant art will recognize that other components and configurations may be used without departing from the spirit and scope of the invention.

This disclosure relates to a system for transmitting message traffic including a MQ network having a plurality of MQ clients coupled to a MQ queue via at least one MQ queue manager and at least one MQ proxy server coupled to the plurality of MQ clients. The MQ proxy servers allow greater efficiency and flexibility in the system's ability to transmit MQ message traffic, while preserving the existing structure, robustness, and inherent security of the MQ network.

At least one MQ proxy server is coupled to a plurality of MQ clients wherein the at least one MQ proxy server retrieves a message from a first MQ client coupled thereto, evaluates the message content and forwards the message to the MQ queue via a designated MQ queue manager. At least one MQ proxy server retrieves the message from the MQ queue thru the designated MQ queue manager, evaluates the message content and forwards the message to the second MQ client. The MQ clients and MQ proxy servers may be coupled through a physical or virtual connection.

The at least one MQ proxy server evaluates the content of the message retrieved from the first MQ client to determine the at least one designated MQ client recipient, and forwards the message retrieved from the first MQ client to the at least one MQ queue manager coupled to the at least one MQ client designated as the message recipient. A MQ proxy server may evaluate the content of the message retrieved from a MQ client or retrieved from a MQ queue manager for formatting compatibility authenticity and/or security threats. When the message format is determined to be incompatible, a MQ proxy server may reconfigure the message upon transmission to the MQ queue or upon message retrieval from the MQ queue depending up on the MQ queue and client requirements.

With traditional MQ messaging different secure level of messages can't multiplex on the same queue. With the instant invention, the MQ proxy server can perform message level security and format or reconfigure the message upon transmission, allowing multiple messages of different security requirements to multiplex on the same queue which simplifies the infrastructure.

The MQ proxy server further enhances messaging flexibility by providing for growth or other changes in message format as the MQ system evolves. As part of service virtualization, the MQ proxy server can transform the data from the format that sender understands to the format that receiver can handle.

The MQ proxy server notifies at least one other MQ proxy server coupled to a second MQ client of the plurality. The notification can be done via existing MQ mechanism of depositing the message in the other MQ proxy server Queue of the designated MQ queue manager. The at least one other MQ proxy server retrieves the message from the MQ queue thru the designated MQ queue manager, evaluates the message content, and forwards the message to a second MQ client. The retrieval operations may be triggered by a second MQ client via the existing MQ GET mechanism. The sending MQ client does not need to know who are the second MQ client of the plurality and the specific MQ queue of the second MQ client. The two endpoints are decoupled with greater flexibility and security.

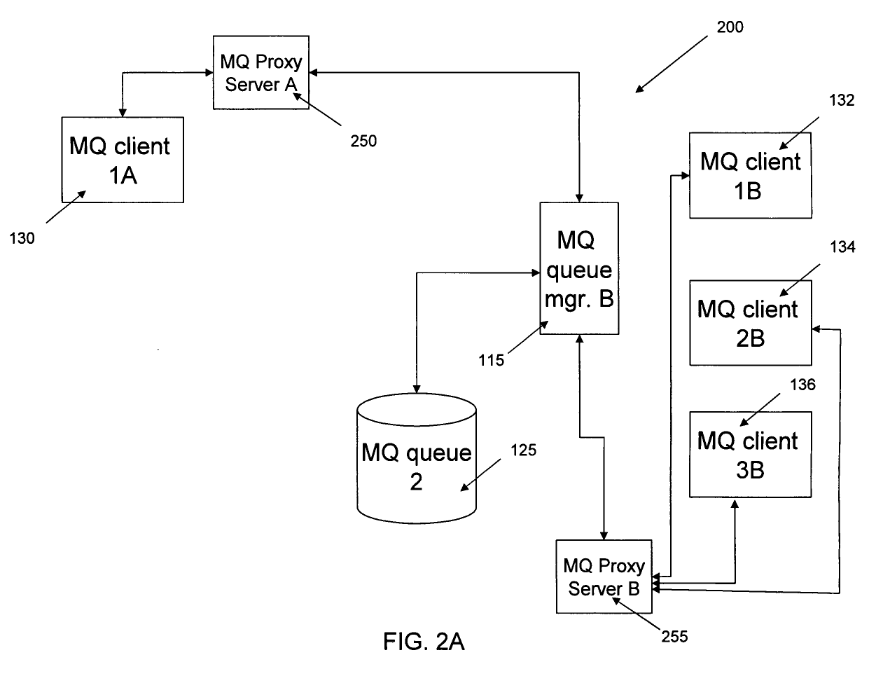

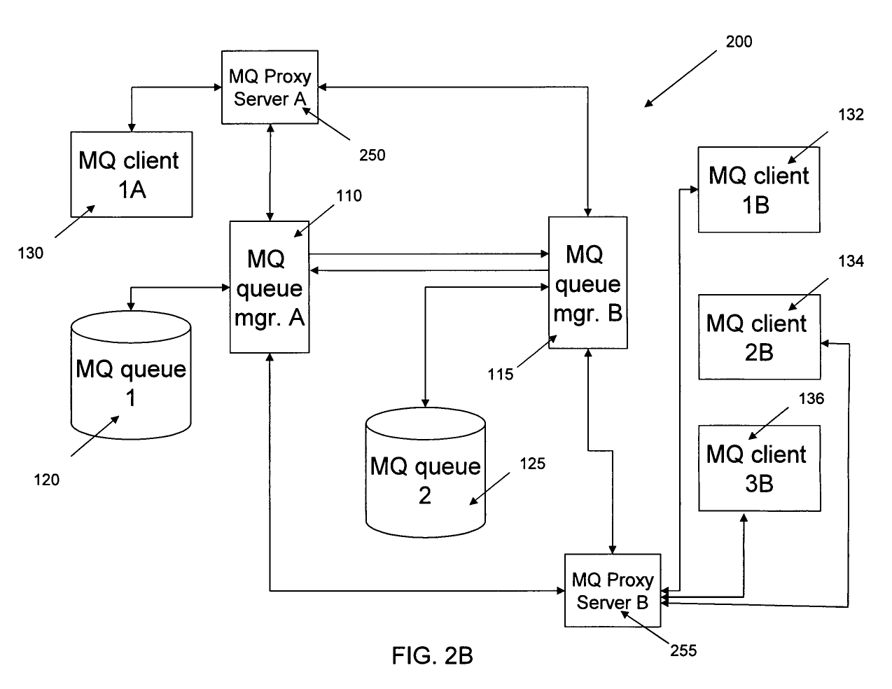

Referring now to FIG. 2A which illustrates a block diagram of an example embodiment of a MQ proxy server messaging system having a plurality of MQ clients serviced by two proxy servers.

The MQ network (200) has a plurality of MQ clients (130, 132, 134, 136) that are coupled to MQ queue (125) through MQ queue manager (115). MQ client 1A (130) is coupled to the MQ queue manager B through MQ proxy server A (250). MQ queue manager B (115) is also coupled to MQ clients 1B, 2B and 3B (132, 134, 136) through MQ proxy server B (255).

The MQ proxy servers (250, 255) are transparent to the MQ client sender, and MQ client destination(s) emulating the MQ queue managers or MQ clients depending on the device they are serving or with which they are communicating. The MQ proxy servers appear to the MQ queue managers as MQ clients, and appear as the MQ managers to the MQ clients.

When MQ client A1 initiates a message to MQ client 3B, the proxy server at the sender side, for example, MQ proxy server A (250) intercepts the message from the sender, MQ client 1A (130) and routes the message, based on predetermined routing rules, to the appropriate MQ queue manager, MQ queue manager B (115). The MQ queue manager B (115) subsequently stores the message in MQ queue 2 (125).

The proxy server at the destination side, MQ proxy server B (255), upon notification retrieves the message form the MQ queue manager B (115) and forwards the message to the ultimate destination, MQ client 3B (136) in this example embodiment, performing a similar function as the MQ proxy server (250) at the sender side.

FIG. 2B illustrates a block diagram of an example embodiment of a MQ proxy server messaging system having a plurality of MQ clients serviced by two proxy servers associated with a plurality of MQ queues.

The MQ network (200) has a plurality of MQ clients (130, 132, 134, 136) that are coupled to MQ queues (120, 125) through MQ queue managers (110) and (115). MQ client 1A (130) is coupled to the MQ queue manager A through MQ proxy server A (250). MQ queue manager B (115) is coupled to MQ clients 1B, 2B and 3B (132, 134, 136) through MQ proxy server B (255). MQ queue managers A and B (110, 115) are also coupled each other through MQ proxy servers A and B (250, 255).

For two MQ queue managers scenario, the MQ queue manager A (110) forwards the message to MQ queue manager A (110). The MQ queue manager A (110) forwards the message to MQ queue manager B (115) which subsequently stores in the message in MQ queue (125). The proxy server at the destination side, MQ proxy server B (255) notified of the pending message destined for MQ client 3B (136) retrieves the message and forwards the message to the ultimate destination, MQ client 3B (136) in this example embodiment, performing a similar function as the MQ proxy server A (250) at the sender side.

In an alternative embodiment the MQ Proxy server A (250) may forward the pending message directly to MQ queue manager B (115) depending on the routing rules, which may be tailored base on system workload, channel availability etc.

By employing MQ proxy servers as disclosed, the present invention allows enhanced service virtualization. The flexibility of existing MQ infrastructure is enhanced since the sender does not need to know the specific queue that the receiver is listing. If the receiver moves from one queue to the other, the sender does not need to know.

The MQ proxy servers depend on the MQ queue managers for reliable delivery of the message traffic they handle.

With continued reference to the example embodiments illustrated in FIGS. 2A and 2B, message traffic from MQ client 1A (130) to MQ client 3B (136) flows as follows. The MQ proxy server A (250) retrieves message traffic from MQ client 1A (130) designating MQ client 3B (136) as a recipient. The MQ proxy server A (250) evaluates the content of the message to determine the designated recipients and proper routing, as well as the formatting requirements. MQ proxy server A (250) also evaluates the message content to determine message authenticity as well as to screen for embedded or other security threats. Based on the system's routing rules, the MQ proxy server (250) forwards the message retrieved from MQ client 1A (130) to MQ queue manager B (115) coupled to the MQ client 3B (136) designated as recipient.

Via existing MQ mechanism, the MQ proxy server A (250) deposits the message in the MQ queue of MQ proxy server B (255) coupled to the destination, MQ client 3B (136). MQ proxy server B (255) retrieves the message from the MQ queue (120) thru the designated MQ queue manager B (115). The MQ proxy server B (255) evaluates the content of the message retrieved from the MQ message queue (120) for security threats, formatting and/or authenticity and forwards the message to the recipient MQ client, MQ client 3B (136).

MQ client 3B (136) is sole designated recipient of the message traffic in this particular example, however the MQ client sending the message may designate a plurality of recipient MQ clients, for example MQ client 1B and 3B (132, 134) as recipients of particular message traffic. Since in this example embodiment MQ proxy server B (255) services MQ clients 1B and 3B (132, 136) MQ proxy server B (255) would perform the retrieval, evaluation, notification and delivery functions for both MQ clients 1B and 3B (132, 136).

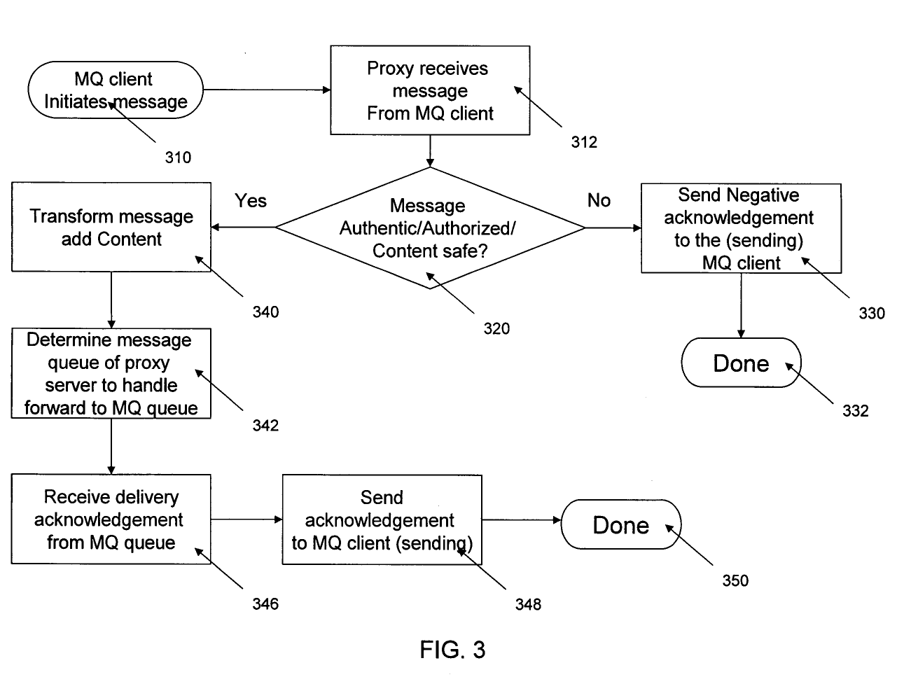

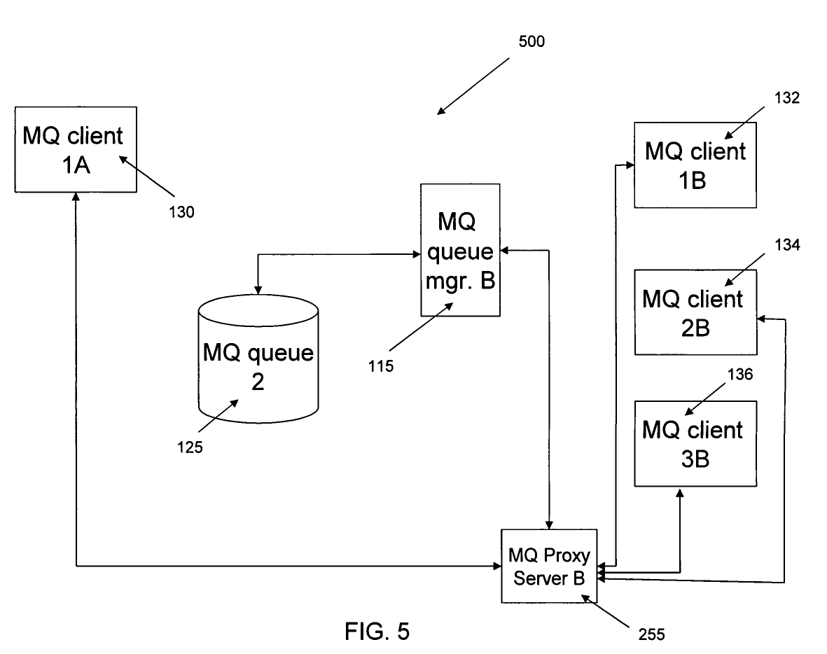

Referring now to FIG. 3, which shows a flowchart of an example embodiment of the MQ proxy server messaging system on the initiating side of the MQ queue, and FIG. 5, which shows a block diagram of an example embodiment (500) of a MQ proxy server messaging system having a plurality of MQ clients serviced by a single proxy server, MQ client 1A (130) initiates a message (310) and the MQ proxy server (250) retrieves the message from the MQ client (312). The retrieved messages content is evaluated by the MQ proxy server (250) for content, authenticity/authorization or harmful content (320) and if the message is determined to have harmful programming or is unauthorized the MQ proxy server (250) sends a negative acknowledgement to the sending MQ client (330) and suspends the process (332).

If the retrieved messages content is determined to be authorized and content safe (320) the MQ proxy server (250) will transform or reconfigure the message and add any necessary content for successful transmission 340. The MQ proxy server (250) determines which MQ queue manager (110) should handle the message and forwards the message to the MQ queue (120) through the appropriate MQ queue manager (110). In the example embodiment of FIG. 5, there is only one MQ proxy server serving this network, so there is no choice of proxy servers, nor proxy notification.

Once the message is forwarded (342) to the MQ queue (120), the MQ proxy server (250) receives a delivery acknowledgement (346) from the MQ queue (120) indicating successful delivery. The MQ proxy server (250) then sends an acknowledgement (348) to the MQ client that initiated the message (130).

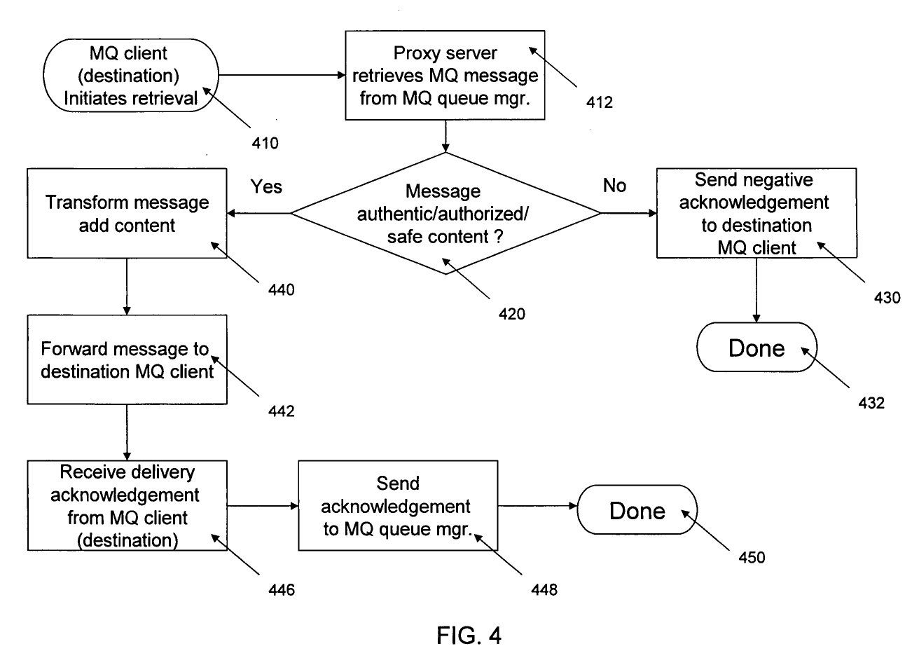

Referring now to FIG. 4, which shows an exemplarily flowchart of the message flow on the destination side of the MQ queue, and with continued reference to FIG. 5, the MQ client on the destination side, MQ client 2B (134) initiates retrieval of the message (410). MQ proxy server (250) receives notice of the message pending in the MQ queue (120) from the sending MQ proxy server (250), here one in the same. MQ proxy server (250) retrieves the MQ message (412) from the MQ queue manager (115) and evaluates the message for content, authenticity/authorization or harmful content (420). If the MQ proxy server (250) determines the message contains harmful programming or is otherwise unauthorized, the MQ proxy server (250) sends a negative acknowledgement to the destination MQ client (430) and suspends the process (432).

If the MQ proxy server (250) determines that the message is authorized and contains safe content, the MQ proxy server (250) transforms or configures the message and may add any necessary content for successful transmission (440).

The MQ proxy server (250) then forwards the message (442) to the destination, MQ client 2B (134) and receives an acknowledgement of successful delivery to the MQ client 2B (134). The MQ proxy server (250) forwards the acknowledgement (448) to the MQ queue manager (115) completing the message transfer.

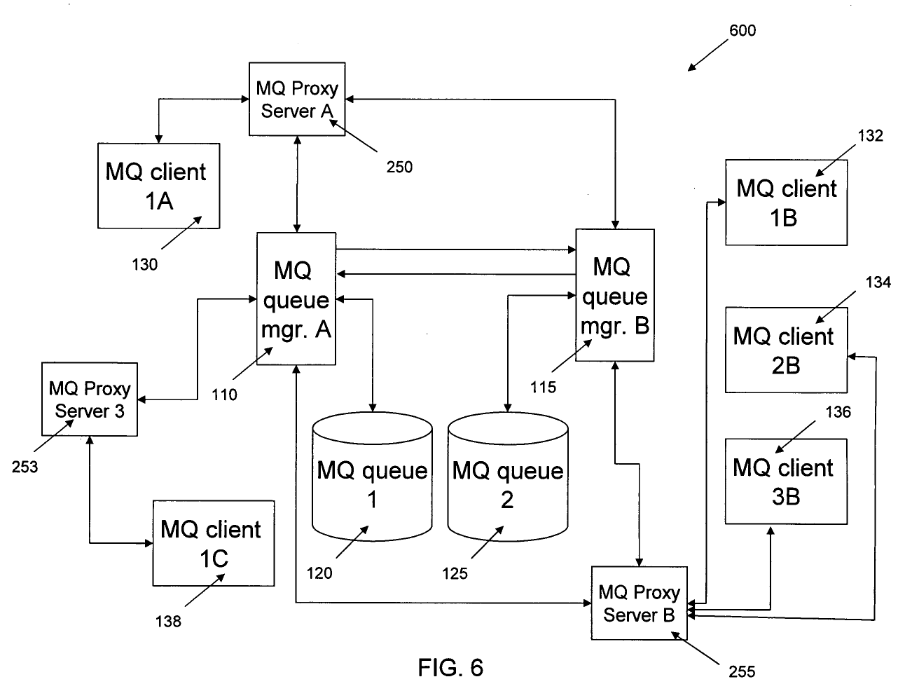

FIG. 6, shows a MQ proxy server messaging system that features three MQ proxy servers (250, 253, 255) servicing a plurality of MQ clients and a plurality of MQ queue managers (110, 115). MQ client 1A (130) is coupled to MQ queue manager A (110) through MQ proxy server A (250). MQ client 1C (132) is similarly coupled to MQ queue manager A (110) through MQ proxy server C (253). MQ clients 1B, 2B, and 3B (132, 134, 136) are coupled to MQ queue manager B (115) through MQ proxy server B (255).

With continued reference to the example embodiment illustrated in FIG. 6, message traffic from MQ client 2B to MQ client 1A and 1C would be transmitted as follows. The message is initiated at MQ client 2B (134) with MQ clients 1A(130) and 1C (138) as addressees. MQ proxy server B (255) serves MQ clients 1B, 2B and 3B (132, 134, 136) as well as MQ queue manager B (115). MQ proxy server B (255) retrieves the message from MQ client 2B (134) and evaluates the message content to determine the designated recipients, 1A (130) and 1C (138), the proper routing as well as the formatting requirements. MQ proxy server B (255) also evaluates the message content to determine authenticity as well as to screen for security threats.

If the message retrieved from the MQ client 2B (134) is determined to be authentic and safe, and if properly configured, MQ proxy server B (255) forwards the message to the MQ queue (125) via at least one designated MQ queue manager serving the recipients. The MQ system may be configured such that a single MQ queue manager may serve a plurality of MQ clients or multiple MQ queue managers may serve several MQ clients. Based on the system's routing rules, the MQ proxy server forwards the message retrieved from MQ client to MQ queue managers coupled to the designated recipients. MQ clients 1A (130) and 1C (138) are served by the same MQ queue manager, MQ queue manager A (110) in this embodiment, so the message is transmitted to MQ queue manager A (110).

The MQ proxy server B (255) notifies MQ proxy server A (250) and MQ proxy server C (253) coupled to the destination, MQ clients 1A (130) and 1C (138). MQ proxy server A (250) and MQ proxy server C (253) both retrieve the message from the MQ queue (120) thru the designated MQ queue manager A (110). The MQ proxy server A (250) evaluates the content of the message retrieved from the MQ message queue (120) through MQ queue manager A (110) for security threats, formatting and/or authenticity and forwards the message to MQ client 1A (130). The MQ proxy server C (253) also evaluates the content of the message retrieved from the MQ message queue (120) through MQ queue manager A (110) for security threats, formatting and/or authenticity and forwards the message to MQ client 1C (138).

It will be understood that each block of the flowchart illustrations and block diagrams and combinations of those blocks can be implemented by computer program instructions and/or means.

Another embodiment of the instant invention is a method for transmitting secure message traffic via an intermediate server application coupled to a plurality of MQ clients. The disclosed method includes the steps of receiving a MQ message from the sending MQ client; authenticating the MQ message received from the sending MQ client; determining the MQ message queue that should handle the message based on the MQ client designated as recipient and, forwarding the MQ message to the designated MQ message queue through a MQ queue manager coupled to the designated MQ message queue. The method also includes retrieving the MQ message from the designated MQ message queue through the MQ queue manager; authenticating the MQ message retrieved from the MQ queue manager and, forwarding the MQ message to the recipient MQ client.

The method also comprises the step of configuring the message retrieved from the sending MQ client or retrieved from the MQ queue manager to facilitate successful transmission of the message to the destination MQ client.

The method also comprises creating secure zones between each of the MQ clients of the plurality and the at least one MQ queue manager, by terminating the processing of the message if the MQ proxy server determines the retrieved message to be unauthorized or to contain harmful content.

In another embodiment of the disclosed invention is a system for transmitting secure message traffic in a MQ network having a plurality of MQ clients coupled to a MQ queue via at least one MQ queue manager and a means for receiving a MQ message from a first MQ client, means for authenticating the MQ message received from the first MQ client and means for determining the message queue of which proxy server should handle the message. The system also features means for forwarding the MQ message to the designated MQ message queue through the MQ queue manager coupled to the designated message queue and means for retrieving the MQ message from the designated message queue through the MQ queue manager coupled thereto. The system also features means for authenticating the MQ message retrieved from the MQ queue manager, as well as means for forwarding the message to the designated MQ client recipient.

The disclosed invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Each of the disclosed means for receiving, means for retrieving, means for forwarding, means for determining, and means for authenticating may take the form of firmware, resident software, microcode, etc. executed in an integrated circuit or an optical, semiconductor, magnetic or electronic device or a combination thereof.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and and optical disk. Current examples of optical disks include compact disk-read only memory, (CD-ROM), compact disk-read/write (CD-R/W) and DVD.

A data processing system suitable for storing and/or executing program code will include at least one processor coupled directly or indirectly to memory elements through a system bus. The memory elements can include a local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters

Another embodiment of the present invention is a computer program product comprising computer usable medium having; a computer usable program code for transmitting secure message traffic via an intermediate server application coupled to a plurality of MQ clients, the computer program product featuring computer-usable program code for receiving a MQ message from a first MQ client; computer-usable program code for authenticating the MQ message received from the first MQ client; and computer-usable program code for determining the MQ message queue that should handle the message.

The computer program product also employs computer-usable program code for forwarding the MQ message to the designated MQ message queue through a MQ queue manager coupled to the designated MQ message queue; computer-usable program code for retrieving the MQ message from the designated MQ message queue through the MQ queue manager, as well as computer-usable program code for authenticating the MQ message retrieved from the MQ queue manager and, forwarding the MQ message to the designated MQ client recipient.

Although specific example embodiments have been illustrated and described herein, those of ordinary skill in the art appreciate that other variations, aspects, or embodiments may be contemplated, and/or practiced without departing from the scope or the spirit of the appended claims.

1. A system for transmitting secure message traffic encapsulating a MQ network comprising:
a plurality of MQ clients coupled to a MQ queue via at least one MQ queue managers; and
at least one MQ proxy server coupled to said plurality of MQ clients;
wherein said at least one MQ proxy server retrieves a message from a first MQ client coupled thereto,
evaluates said message content and forwards said message to said MQ queue via a designated MQ queue manager;
retrieves said message from said MQ queue thru said designated MQ queue manager; and
evaluates said message content and forwards said message to said second MQ client.

2. The system of claim 1, wherein said at least one MQ proxy server evaluates the content of said message retrieved from said first MQ client to determine the at least one designated MQ client recipient, and forwards said message retrieved from said first MQ client to said at least one MQ queue manager coupled to the at least one MQ client designated as recipient.

3. The system of claim 2, wherein said MQ proxy server notifies at least one other MQ proxy server coupled to a second MQ client of the plurality, said at least one other MQ proxy server;
wherein said at least one other MQ proxy server retrieves said message from said MQ queue thru said designated MQ queue manager,
evaluates said message content, and forwards said message to a second MQ client.

4. The system of claim 2, wherein said at least one MQ proxy server evaluates the content of said message retrieved from said first MQ client for authenticity.

5. The system of claim 2, wherein said at least one MQ proxy server evaluates the content of said message retrieved from first said MQ client for security threats.

6. The system of claim 2, wherein said MQ proxy server evaluates the content of said message retrieved from said MQ message queue for authenticity.

7. The system of claim 2, wherein said at least one MQ proxy server evaluates the content of said message retrieved from said MQ message queue for security threats.

8. The system of claim 2, wherein said at least one MQ proxy server receives an acknowledgement of message delivery from the MQ queue, and delivers said acknowledgement to said first MQ client.

9. The system of claim 2, wherein said at least one MQ proxy server receives an acknowledgement of message delivery from said second MQ client and delivers said acknowledgement to the MQ queue manager.

10. The system of claim 2, wherein said at least one MQ proxy server configures the message upon transmission to said MQ queue.

11. The system of claim 2, wherein said at least one MQ proxy server configures the message upon forwarding said message to said second MQ client.

12. The system of claim 2, wherein said at least one MQ proxy server emulates a MQ client when forwarding message traffic to said at least one MQ queue manager.

13. The system of claim 2, wherein said at least one MQ proxy server emulates the MQ queue manager when delivering message traffic to said MQ clients.

14. A method for transmitting secure message traffic via an intermediate server application coupled to a plurality of MQ clients comprising:
receiving a MQ message from the sending MQ client;
authenticating said MQ message received from said sending MQ client;
determining the MQ message queue that should handle the message based on the MQ client designated as recipient and,
forwarding the MQ message to the designated MQ message queue through a MQ queue manager coupled to said designated MQ message queue;
retrieving said MQ message from said designated MQ message queue through said MQ queue manager;
authenticating said MQ message retrieved from said MQ queue manager and,
forwarding said MQ message to the recipient MQ client.

15. The method of claim 14, further comprising the step of terminating the processing of said message if said MQ proxy server determines said message to be unauthorized.

16. The method of claim 14, further comprising the step of configuring the message retrieved from said sending MQ client.

17. The method of claim 14, further comprising the step of configuring the message retrieved from said MQ queue manager.

18. The method of claim 14, further comprising creating secure zones between each said MQ clients of the plurality and said at least one MQ queue manager.

19. A system for transmitting secure message traffic encapsulating a MQ network comprising:
a plurality of MQ clients coupled to a MQ queue via at least one MQ queue manager;
means for receiving a MQ message from a first MQ client;
means for authenticating said MQ message received from said first MQ client;
means for determining the message queue of which proxy server should handle the message;
means for forwarding the MQ message to the designated MQ message queue through said MQ queue manager coupled to the designated message queue;
means for retrieving said MQ message from said designated message queue through the MQ queue manager coupled thereto;
means for authenticating said MQ message retrieved from said MQ queue manager; and
means for forwarding the message to the designated MQ client recipient.

20. A computer program product comprising computer usable medium having; a computer usable program code for transmitting secure message traffic via an intermediate server application coupled to a plurality of MQ clients, said computer program product comprising:
computer-usable program code for receiving a MQ message from a first MQ client;
computer-usable program code for authenticating said MQ message received from said first MQ client;
computer-usable program code for determining the MQ message queue that should handle the message;
computer-usable program code for forwarding the MQ message to the designated MQ message queue through a MQ queue manager coupled to the designated MQ message queue;
computer-usable program code for retrieving said MQ message from said designated MQ message queue through said MQ queue manager; and
computer
-usable program code for authenticating said MQ message retrieved from said MQ queue manager and;
forwarding said MQ message to the designated MQ client recipient.
